(19) United States
(12) Patent Application Publication
(10) Pub. No.: US 2014/0186478 A1
(43) Pub. Date: Jul. 3, 2014

(54) MOLD FOR FABRICATING OPTICAL FIBER CONNECTOR

(71) Applicant: HON HAI PRECISION INDUSTRY CO., LTD., New Taipei (TW)

(72) Inventor: CHANG-WEI KUO, New Taipei (TW)

(21) Appl. No.: 13/945,883

(22) Filed: Jul. 18, 2013

(30) Foreign Application Priority Data
Dec. 28, 2012 (TW) 101150932

(51) Int. Cl. B29D 11/00

(52) U.S. Cl. CPC B29D 11/0075
USPC 425/121

(57) ABSTRACT

A mold for fabricating an optical fiber connector includes a first plate-shaped core with a first forming surface, a second plate-shaped core with a second forming surface, and a female mold. The female mold includes a first surface and a second surface. The female mold defines a first through hole and a second through hole. Both the first through hole and the second through hole run through the first surface and the second surface. The first through hole opens in the first surface as a first front assembly opening. The first plate-shaped core is inserted into the first through hole with the first forming surface, such that the first plate-shaped core extends a distance out of the first front assembly opening. The second plate-shaped core is inserted into the second through hole, with the second forming surface being coplanar with the first surface.

### BACKGROUND

1. Technical Field

The present disclosure relates to molds, and particularly to a mold for fabricating an optical fiber connector.

2. Description of Related Art

Optical fiber connectors are widely used as interfaces for high-speed transmission of electronic data between two electronic devices. An optical fiber connector is fabricated using an injection mold, and includes a male connector and a female connector coupled with the male connector. The male connector and the female connector each include a lens portion, a blind hole facing the lens portion, and an optical fiber accommodated in the blind hole. However, it is difficult to make the lens portions which have difficult lengths to optically coaxial with the optical fiber.

Therefore, it is desirable to provide a mold for fabricating an optical fiber connector that can overcome the above-mentioned limitations.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an assembled, isometric view of a mold in accordance with an exemplary embodiment.

FIG. 2 is similar to FIG. 1, but viewed from another angle.

FIG. 3 is an exploded, isometric view of the mold of FIG. 1.

### DETAILED DESCRIPTION

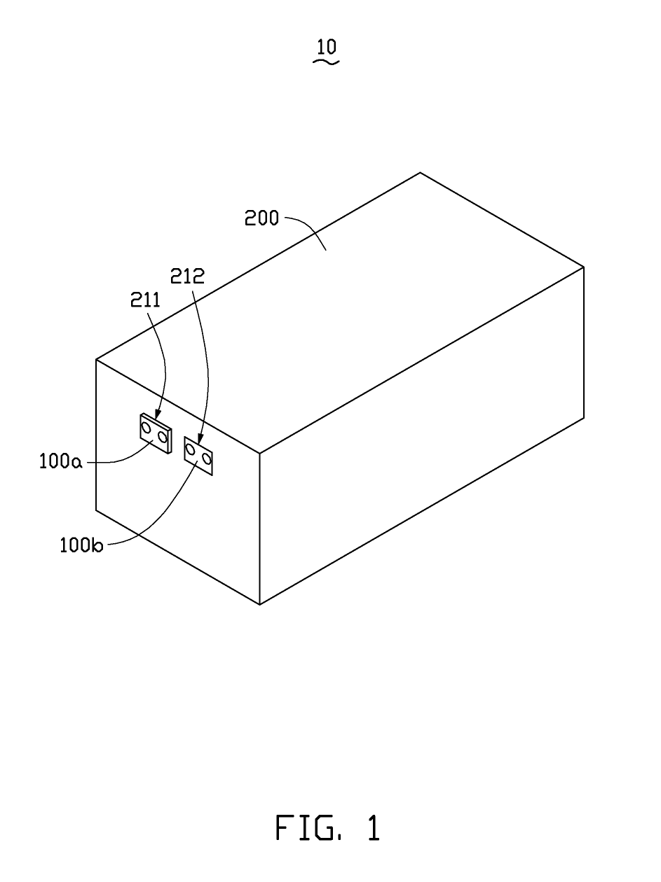

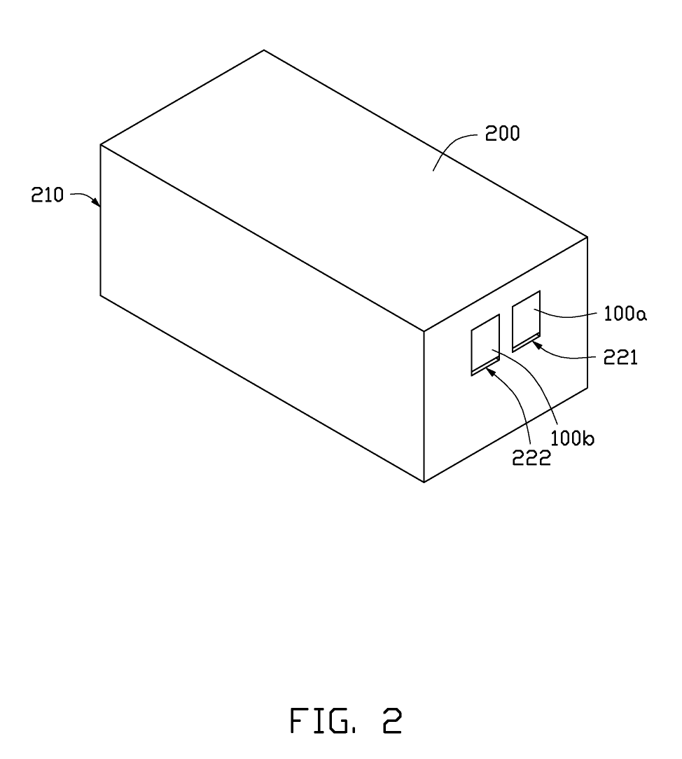

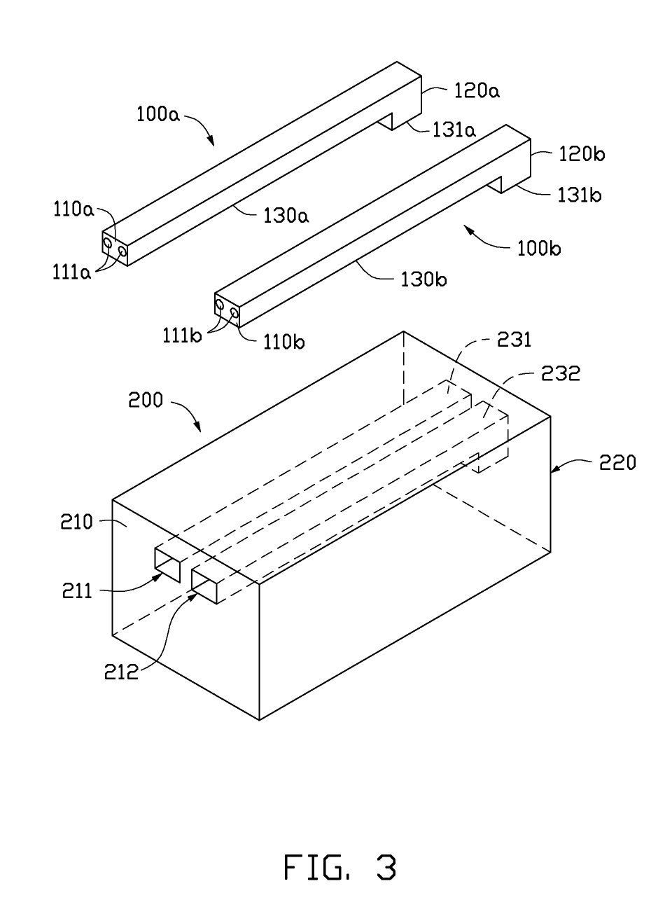

FIGS. 1-3 show a mold 10 configured for fabricating an optical fiber connector. The mold 10 includes a first plate-shaped core 100a, a second plate-shaped core 100b, and a female mold 200. The first plate-shaped core 100a and the second plate-shaped core 100b are configured for forming four aspherical lens portions of the optical fiber connector. The first plate-shaped core 100a, the second plate-shaped cores 100b, and the female mold 200 all are substantially rectangular.

The first plate-shaped core 100a includes a first forming surface 110a, a first rear surface 120a facing away from the first forming surface 110a, and a first bottom surface 130a. The first forming surface 110a is substantially parallel to the first rear surface 120a. The first bottom surface 130a substantially perpendicularly connects the first forming surface 110a to the first rear surface 120a.

The first plate-shaped core 100a defines two first recesses 111a in the first forming surface 110a. The two first recesses 111a separate from each other. In the embodiment, each first recess 111a has substantially the same shape and size as an aspherical lens portion to be fabricated. The aspherical lens portions each optically couple with an optical fiber.

The first plate-shaped core 100a includes a first flange 131a perpendicularly extending from one end of the first bottom surface 130a adjacent to the first rear surface 120a. A rear surface of the first flange 131a and the first rear surface 120a are coplanar with each other.

The second plate-shaped core 100b includes a second forming surface 110b, a second rear surface 120b facing away from the second forming surface 110b, and a second bottom surface 130b. The second forming surface 110b is substantially parallel to the second rear surface 120b. The second bottom surface 130b substantially perpendicularly connects the second forming surface 110b to the second rear surface 120b.

The second plate-shaped core 100b defines two second recesses 111b in the second forming surface 110b. The two second recesses 111b separate from each other. In the embodiment, each second recess 111b has substantially the same shape and size as the aspherical lens portion to be fabricated.

The second plate-shaped core 100b includes a second flange 131b extending substantially perpendicularly from one end of the second bottom surface 130b adjacent to the second rear surface 120b. A rear surface of the second flange 131b and the second rear surface 120a are coplanar.

The female mold 200 includes a first surface 210 and a second surface 220 facing away from the first surface 210. The female mold 200 defines a first through hole 231 and a second through hole 232. Both the first through hole 231 and the second through hole 232 run through the first surface 210 and the second surface 220, and are spaced from each other. The first through hole 231 has substantially the same shape as the first plate-shaped core 100a, and is configured to partly receive the first plate-shaped core 100a. In the embodiment, a length of the first through hole 231 is shorter than a length of the first plate-shaped core 100a along a direction substantially perpendicular to the first surface 210. The second through hole 232 has substantially the same size and shape as the second plate-shaped core 100b, and is configured to totally receive the second plate-shaped core 100b. In the embodiment, a length of the second through hole 232 is substantially equal to a length of the second plate-shaped core 100b along a direction perpendicular to the first surface 210.

The first through hole 231 opens in the first surface 210 as a first front assembly opening 211. The first front assembly opening 211 has substantially the same size and shape as the first forming surface 110a. The second through hole 232 opens in the first surface 210 as a second front assembly opening 212. The second front assembly opening 212 has the same size and shape as the second forming surface 110b. The first through hole 231 opens in the second surface 220 as a first rear assembly opening 221. The first rear assembly opening 221 has the same size and shape as the first rear surface 120a. The second through hole 232 opens in the second surface 220 as a second rear assembly opening 222. The second rear assembly opening 222 has the same size and shape as the second rear surface 120b.

In assembly, firstly, the first plate-shaped core 100a is inserted into the first through hole 231 through the first rear assembly opening 221, with the first forming surface 110a extending a distance out of the first front assembly opening 211, and with the first rear surface 120a being coplanar with the second surface 220. The inserting distance can be set according to requirements. Then, the second plate-shaped core 100b is inserted into the second through hole 232 through the second rear assembly opening 222, with the second forming surface 110b being coplanar with the first surface 210, and with the second rear surface 120b being coplanar with the second surface 220. The first forming surface 110a and the second forming surface 110b are not coplanar with each other, as such, the mold 100 makes the lens portions having difficult lengths.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A mold for fabricating an optical fiber connector, the optical fiber connector comprising a plurality of aspherical lens portions each for optically coupling with an optical fiber, the mold comprising:
a first plate-shaped core comprising a first forming surface;
a second plate-shaped core comprising a second forming surface; and
a female mold comprising a first surface and a second surface facing away from the first surface, the female mold defining a first through hole and a second through hole, both the first through hole and the second through hole running through the first surface and the second surface, the first through opening in the first surface as a first front assembly opening, the first plate-shaped core inserted into the first through hole with the first forming surface extending a distance out of the first front assembly opening, the second plate-shaped core inserted into the second through hole, with the second forming surface being coplanar with the first surface.

2. The mold of claim 1, wherein the first plate-shaped core, the second plate-shaped cores and the female mole all are substantially rectangular.

3. The mold of claim 1, wherein the first plate-shaped core comprises a first rear surface facing away from the first forming surface and a first bottom surface, the first bottom surface connects the first forming surface to the first rear surface, the first plate-shaped core comprises a first flange extending from one end of the first bottom surface adjacent to the first rear surface, a rear surface of the first flange and the first rear surface are coplanar with each other, the first rear surface is coplanar with the second surface.

4. The mold of claim 3, wherein the first through hole opens in the second surface as a first rear assembly opening, the first rear assembly opening has substantially the same size and shape as the first rear surface, the first plate-shaped core is inserted into the first through hole through the first rear assembly opening.

5. The mold of claim 1, wherein the second plate-shaped core comprises a second rear surface facing away from the second forming surface and a second bottom surface, the second bottom surface connects the second forming surface to the second rear surface, the first plate-shaped core comprises a second flange extending from one end of the second bottom surface adjacent to the second rear surface, a rear surface of the second flange and the second rear surface are coplanar with each other, the second rear surface is coplanar with the second surface.

6. The mold of claim 5, wherein the second through hole opens in the second surface as a second rear assembly opening, the second rear assembly opening has the same size and shape as the second rear surface, the second plate-shaped core is inserted into the second through hole through the second rear assembly opening.

7. The mold of claim 1, wherein the first plate-shaped core defines at least two first separated recesses in the first forming surface.

8. The mold of claim 7, wherein each of the first separated recesses has substantially the same shape and size.

9. The mold of claim 1, wherein the second plate-shaped core defines at least two second separated recesses in the second forming surface.

10. The mold of claim 9, wherein each of the second separated recesses has substantially the same shape and size.

11. The mold of claim 1, wherein the first through hole has substantially the same size and shape as the first plate-shaped core, and is configured to partly receive the first plate-shaped core.

12. The mold of claim 1, wherein a length of the first through hole is shorter than a length of the first plate-shaped core.

13. The mold of claim 1, wherein the second through hole has substantially the same size and shape as the second plate-shaped core, and is configured to totally receive the second plate-shaped core.

14. The mold of claim 1, wherein a length of the second through hole is substantially equal to a length of the second plate-shaped core.

15. The mold of claim 1, wherein the first front assembly opening has substantially the same size and shape as the first forming surface.

16. The mold of claim 1, wherein the second through hole opens in the first surface as a second front assembly opening, and the second front assembly opening has substantially the same size and shape as the second forming surface.
